(19) United States
(12) Patent Application Publication
(10) Pub. No.: US 2012/0050339 A1
(43) Pub. Date: Mar. 1, 2012

(54) Dynamic LED Driving Current Compensation for Cross-Panel Backlight Illumination Uniformity

(76) Inventors: Jiandong Huang, Vancouver, WA (US); Apostolos T. Voutsas, Portland, OR (US)

(21) Appl. No.: 12/875,891

(22) Filed: Sep. 3, 2010

Related U.S. Application Data
(63) Continuation-in-part of application No. 12/873,188, filed on Aug. 31, 2010.

(51) Int. Cl. G09G 5/10

(52) U.S. Cl. 345/690

(57) ABSTRACT

A dynamic light emitting diode (LED) driving current compensation method is provided for ensuring cross-panel backlight illumination uniformity in a display device. A backlight panel includes a plurality of waveguide pipes and a front panel with a plurality of pixel rows. Each row overlies a corresponding waveguide pipe and includes a plurality of selectively enabled pixels formed in a sequence along the row. Light is supplied from a plurality of LEDs, where each LED supplies light to a corresponding waveguide pipe. For each front panel row, a pixel is selected for enablement and an LED drive current is selected in response to the enabled pixel. The LED drive current is selected in response to the distance between the waveguide pipe position underlying an enabled pixel in a corresponding front panel row and the first light interface.

### RELATED APPLICATION

The application is a Continuation-in-Part of a pending application entitled, THREE-DIMENSIONAL DISPLAY USING ANGULAR PROJECTION BACKLIGHT, invented by Huang et al., Ser. No. 12/873,188, filed on Aug. 31, 2010, Attorney Docket No. SLA2739, which is incorporated herein by reference.

### BACKGROUND OF THE INVENTION

1. Field of the Invention

This invention generally relates to electronic display devices and, more particularly, to an edge-coupled backlight capable of creating uniform illumination for an overlying front panel pixel array.

2. Description of the Related Art

With the success of 3D movies, it is expected that 3D television will finally go mainstream. Currently, there are many 3D displays on the market. Most of them require specially designed glasses to create different images in audience's left and right eyes. In addition, the displays must operate in special 3D modes to be compatible with the glasses. From the viewer's perspective, it is desirable to see 3D images without the need of special glasses. In addition, for many handheld portable devices, it is hard to justify the extra cost for the viewing glasses.

As the thickness of flat-panel liquid crystal (LC) displays is reduced to below 1 centimeter (cm), conventional backlight designs such as compact fluorescent lamp (CFL), which require that the light sources be distributed across the backlight panels, cannot be used due to the geometry limitations of these light sources. Ultra-thin display designs might be implemented using LEDs with small-volume packages. But the cost of these implementations can be high since a large number of LEDs would be required.

Display designs with edge-coupled LEDs using large-size multiple-mode waveguide light pipes enable ultra-thin LC display designs while reducing the number of LEDs used in those displays as well. The edge-coupled schemes reduce the cost of backlight dramatically in addition to supporting the stylish thin look of the displays.

However, the image quality of these edge-coupled displays cannot match that of displays using distributed LEDs as backlight light sources in the backlight panels. For the latter case, each LED light extraction cell of the backlight systems can be individually addressed to create low resolution images of desired images. With the synchronization of backlight low resolution images, in time and spatial domain, to the images on the front high-resolution LC panels, high quality images can be realized with higher contrasts and dynamic responses. In this kind of display implementation, the capability to address desired backlight light extraction cells is the key enabling technology, which is not easily achievable using edge-coupled LED backlight systems.

FIG. 1 is a graph depicting backlight waveguide intensity as a function of distance from the light source. The losses from material absorption in a waveguide lead to a non-uniform distribution of light intensity along the length of a waveguide light pipe. The figure also shows the losses contrasted to achievable TV panel sizes. Note:
WG=Waveguide;
Lwg=Length of waveguide;
K (or k)=Extinction coefficient;
X=Defines the size range for the horizontal and vertical dimensions of the display panel. Referring to FIG. 1, X_{horizontal}=3.5″ to 56″ and X_{vertical}=3.5″ to 31.5; and,
D=Display panel diagonal.

It would be advantageous if a mechanism existed to compensate for light attenuation in a waveguide pipe that would enable a waveguide to provide a uniform distribution across the entire length of a waveguide pipe.

### SUMMARY OF THE INVENTION

Disclosed herein is a method that takes advantage of the design principles of active backlight system to create a uniform distribution of light across a waveguide light pipe in a display backlight, thus leading to an overall uniform illumination distribution across the entire backlight panel.

Accordingly, a dynamic light emitting diode (LED) driving current compensation method is provided for ensuring cross-panel backlight illumination uniformity in a display device. A backlight panel includes a plurality of waveguide pipes and a front panel with a plurality of pixel rows. Each row overlies a corresponding waveguide pipe and includes a plurality of selectively enabled pixels formed in a sequence along the row. Light is supplied from a plurality of LEDs, where each LED supplies light to a corresponding waveguide pipe. For each front panel row, a pixel is selected for enablement and an LED drive current is selected in response to the enabled pixel. More explicitly, each waveguide pipe has a first light interface and a plurality of top surface positions. Each position is associated with a pixel in a corresponding front panel row and is a predetermined distance from the first light interface. The LED drive current is selected in response to the distance between the waveguide pipe position underlying an enabled pixel in a corresponding front panel row and the first light interface.

Additional details of the above-described method, and a display device with dynamic LED driving current compensation for ensuring cross-panel backlight illumination uniformity, are provided below.

### BRIEF DESCRIPTION OF THE DRAWINGS

FIG. 1 is a graph depicting backlight waveguide intensity as a function of distance from the light source.

FIGS. 2A and 2B are, respectively, partial cross-sectional and plan views of a display device with dynamic light emitting diode (LED) driving current compensation for ensuring cross-panel backlight illumination uniformity.

FIG. 3 is a plan view of a variation of the display illustrated in FIGS. 2A and 2B.

FIG. 4 is a schematic illustrating distributed light intensity in one waveguide light pipe of a backlight panel.

FIG. 5 is a schematic illustrating the light intensity increase (or decrease) for each light extraction cell (or pixel) required to achieve cross backlight panel uniformity of illuminations at desired intensity level when an LED is driven at current level I_{O}.

FIG. 6 is a schematic illustrating the compensation amounts for LED drive current at desired time slots required to achieve cross panel uniform illumination.

FIG. 7 is a flowchart illustrating a dynamic LED driving current compensation method for ensuring cross-panel backlight illumination uniformity in a display device.

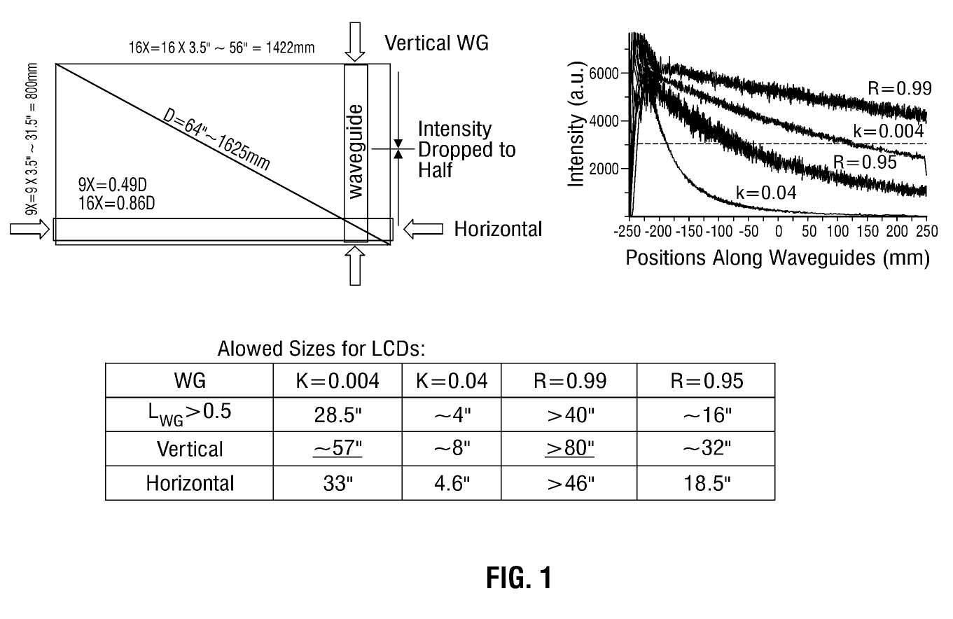

### DETAILED DESCRIPTION

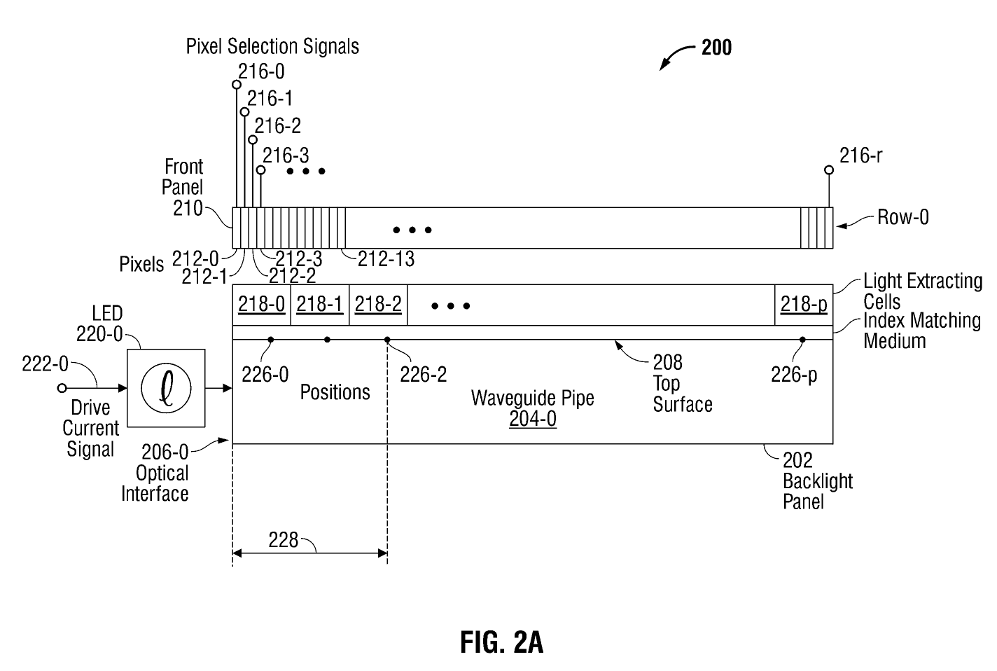

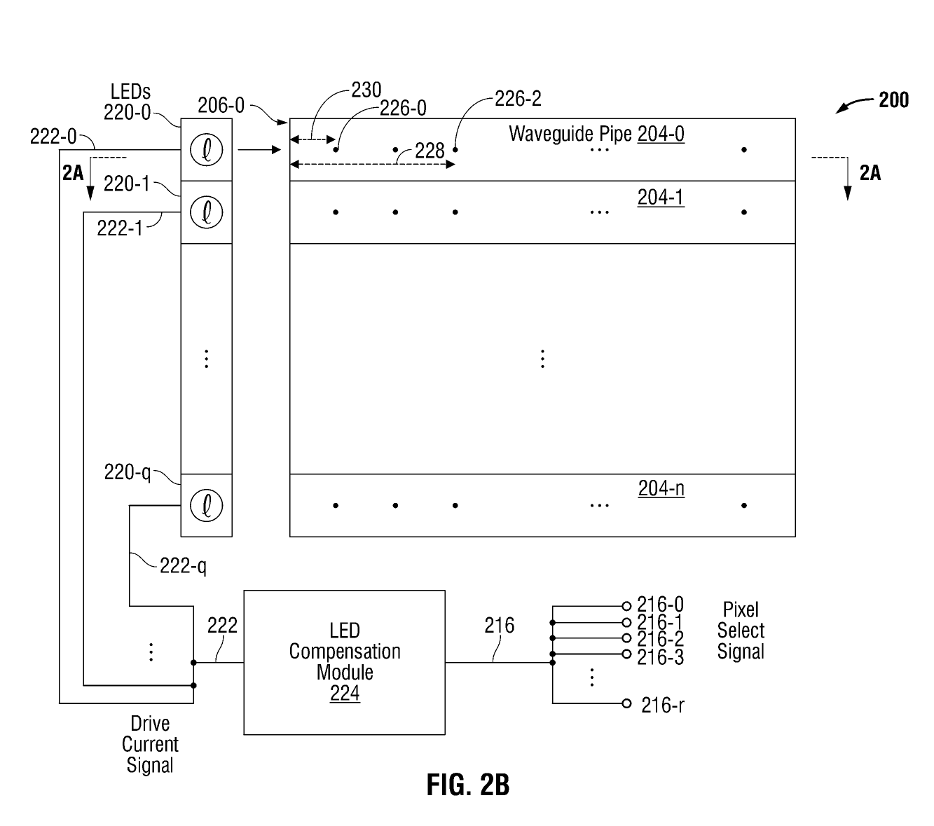

FIGS. 2A and 2B are, respectively, partial cross-sectional and plan views of a display device with dynamic light emitting diode (LED) driving current compensation for ensuring cross-panel backlight illumination uniformity. The device 200 comprises a backlight panel 202 with a plurality of waveguide pipes 204. Each waveguide pipe 204 has an optical interface 206 and a top surface 208 to supply redirected light received via the optical interface 206. Shown are waveguide pipes 204-0 through 204-n, where n is a variable not limited to any particular value. A front panel 210 includes a plurality of rows 212, where each row 212 overlies the top surface 208 of a corresponding waveguide pipe 204. Each row 212 includes a plurality of pixels 214 formed in a sequence along the row. Each pixel 214 has an electrical input on line 216 to accept a pixel selection signal for enabling a selected pixel 214 to transmit redirected light received from a corresponding waveguide pipe 204. Shown are rows 212-0 through 212-m. For simplicity, the drawing depicts a single row of pixels associated with each waveguide pipe. More typically however, each waveguide pipe may be associated with a plurality of adjacent pixels rows.

The pixels are conventionally color pixels. Color pixel arrays are well known in the art and the display 200 may be enabled with any type of front panel requiring a backlight. In one aspect, each pixel may be comprised of subpixels. For example, the subpixels may be associated with red, green, and blue (RGB) colors. In one aspect, the pixels in each row 212 may be connected in parallel. However, since the pixels can be enabled on a row-by-row basis, pixels may be uniquely enabled for a particular row or group of adjacent rows. In another aspect, each pixel is assigned a unique pixel selection line.

Also shown is an array of light gating or light extraction cells 218. Shown are light extraction cells 218-0 through 218-p. The light extraction cells are interposed between the waveguide pipes 204 and the front panel 210. When a pixel is enabled, the light extraction cell underlying the pixel is simultaneously enabled. In one aspect a light extraction cell is larger than a front panel pixel, so that a plurality of pixels may be associated with a light extraction cell, or a plurality of adjacent pixels are enabled when a particular light extraction cell is enabled. In one aspect, the light extraction cells 208 are formed from liquid crystal (LC) cells interposed between transparent electrodes.

The display 200 also comprises a plurality of LEDs 220. Each LED 220 has an electrical input on line 222 to accept a drive current signal. Each LED supplies light to a corresponding waveguide pipe optical interface 206 with an intensity responsive to the drive current signal. Shown are LEDs 220-0 through 220q. Note: for simplicity a single LED is shown associated with each waveguide optical interface 206. However, it should be understood that more than one LED may be assigned to a waveguide optical interface.

An LED compensation module 224 has an electrical input on line 216 to accept the pixel selection signal for each row and an output on line 222 to supply the drive current signal to each LED 220. The drive current signal to each LED is responsive to the selected pixel in a corresponding front panel row. Alternately, the drive current to each LED may be responsive to a selected light extraction cell, which is indirectly related to an enabled pixel or set of pixels associated with the selected light extraction cell. Note: the front panel and array of light extraction cells are not shown in FIG. 2B.

More explicitly, the top surface 208 of each waveguide pipe 204 includes a sequence of positions 226 having a predetermined distance from the optical interface, where each position 226 is associated with a pixel (or set of pixels) in a corresponding front panel row. For example, position 226-2 is a distance 228 from optical interface 206-0. For simplicity, p number of positions are shown, one position for each light extraction cell. However, there need not be a 1:1 relationship between positions and light extraction cells. The LED compensation module 224 supplies the drive current signal on line 222 to an LED 220 in response to the distance 228 between the optical interface and waveguide position in a corresponding waveguide pipe, where the waveguide position underlies a selected pixel in a corresponding front panel row.

For example, waveguide pipe 204-0 has a first optical interface 206-0. The LED compensation module 224 supplies a first drive current signal on line 220-0 to LED 220-0 in response to a first pixel (e.g., pixel 212-2) being enabled in a corresponding front panel row (e.g., row-0). The first position 226-0 in corresponding waveguide pipe 204-0 underlies the first pixel and is a first distance 230 from the first optical interface 206-0. In contrast, the LED compensation module 224 supplies a second drive current signal to the first LED 220-0, in response to a second pixel (e.g., 212-13) being subsequently enabled in the corresponding front panel row (row-0), where a second position 226-2 in the corresponding waveguide pipe 204-0 underlying the second pixel is a second distance 228 from the first light interface 206-0, and the second distance 228 is greater than the first distance 230. As a result, LED 220-0 supplies light with a first intensity via the first optical interface 206-0 in response to the first drive current signal, and supplies light with a second intensity in response to the second drive current signal, where the second intensity is greater than the first intensity. Each waveguide pipe 204 has an illumination loss between the light interface 206 and a position 226 in the top surface 208, responsive to the distance of the position from the light interface. However, each front panel row transmits uniform backlight illumination, regardless of which pixel is enabled in the row.

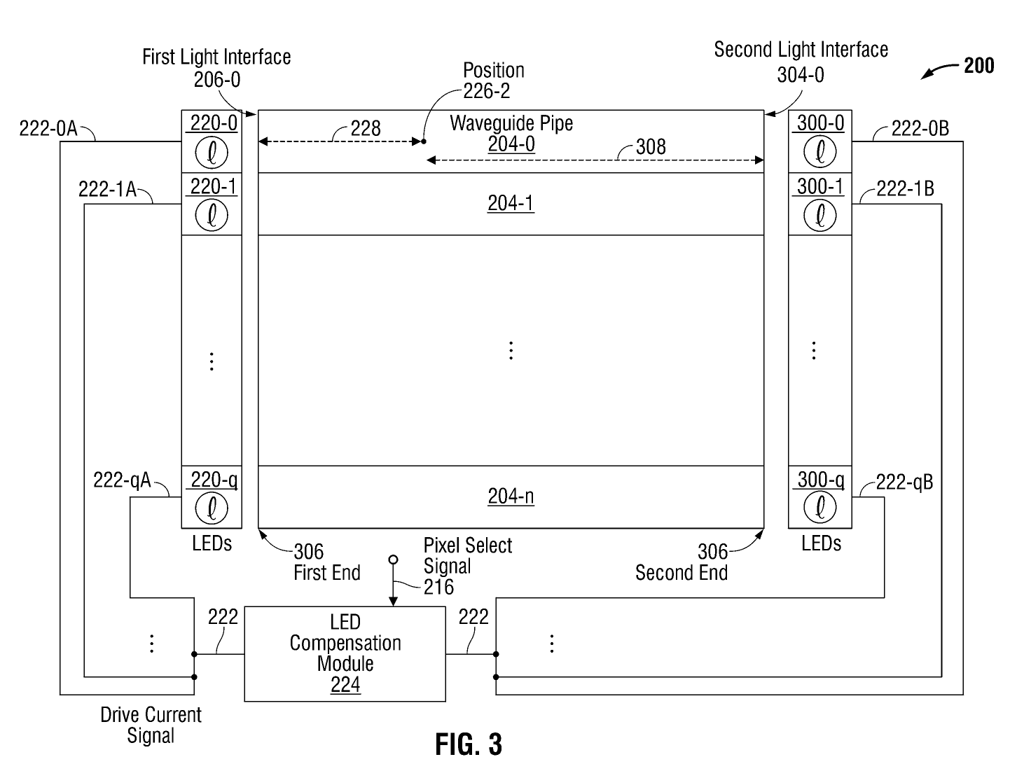

FIG. 3 is a plan view of a variation of the display illustrated in FIGS. 2A and 2B. In this aspect each waveguide pipe 204 includes a bi-direction light interface, with the first light interface 206 is proximate to a first end 302 of each waveguide pipe and a second light interface 304 is proximate to a second end of each waveguide pipe 306. A plurality of LEDs 300 is interfaced to the second light interface 304 of each waveguide pipe.

For example, a first LED 220-0 supplies light to the first optical interface 206-0 of a first waveguide pipe 204-0 and a second LED 300-0 supplies light to the second optical interface 304-0 of the first waveguide pipe. The LED compensation module 224 supplies a first drive current signal on line 222-0A to the first LED 222-0 in response to a first pixel in a corresponding front panel row being enabled, where a first position 226-2 in a corresponding waveguide pipe 204-0 underlying the first pixel is a first distance 228 from the first optical interface 206-0. The LED compensation module 224 supplies a second drive current signal on line 222-0B to the second LED 300-0 in response to the first position 226-2 in the corresponding waveguide pipe 204-0 being a second distance 308 from the second optical interface 304-0. The first LED 220-0 supplies light with a first intensity in response to the first drive current signal on line 222-0A, and the second LED 300-0 supplies light with a second intensity in response to the second drive current signal on line 222-0B.

In one aspect, each waveguide pipe has an illumination loss between a light interface and a position on the top surface that linearly increases in response to the distance between the position and a light interface. Then, the LED compensation module 224 sums the first distance with the second distance, divides the summed distance by 2, creating an average distance, and provides equal drive current signals to the first and second LEDs 220-0 and 300-0 responsive to the average distance. Alternately, the illumination loss is non-linear and the calculation of drive currents is more complicated.

### Functional Description

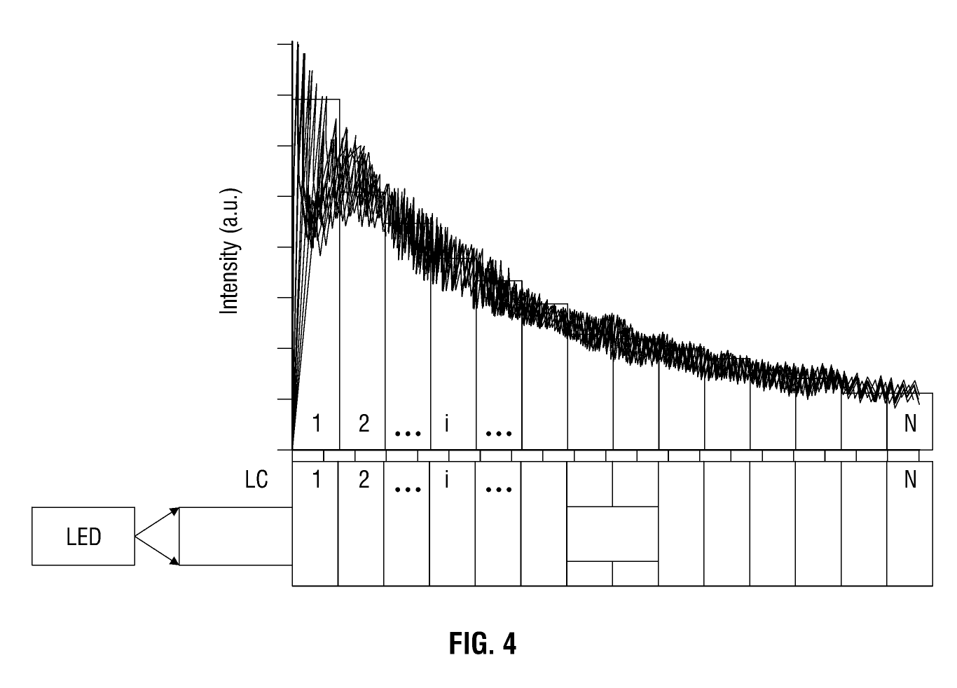

FIG. 4 is a schematic illustrating distributed light intensity in one waveguide light pipe of a backlight panel. Due to material absorption, the light intensity gradually decays, leading to a decayed light extraction away from the LED, assuming that the LED supplies a uniform intensity light. For a single-sided LED input, as shown in FIGS. 2A and 2B, the light intensity, U(i), inside the waveguide light pipe decreases with the distance of the enabled pixel from the waveguide pipe light interface, as i increases from 1 to N (where N stands for the total number of pixels or light extraction cells), as follows:

U=U(i)<U(j), with I>j, i, j within [1,N] Equation 1

By assuming all the light extraction cells have similar extracting efficiencies, η, the illumination intensity, P(i) at each pixel can then described as:

P(i)=η×U(i) Equation 2

which exhibits a similar response as U(i), as shown in Equation 1.

In addition, if linearity can be assumed, the light coupled into a waveguides at the input end, U(0), can be described as:

U(0)=E×γ Equation 3

where E is the total light output from an LED and γ is the coupling efficiency of waveguide and LEDs. E is the function of the LED drive current, I, so that E=E(I).

So, P(i) can be further described as

P(i)=E(I)×γ×η×M(i→0) Equation 4

where M(i→0) describes the loss-induced light intensity decreasing factors as distance of the light extraction cells from the waveguide light interface. Clearly, P(i) can be determined by the input currents of LEDs, and Equation 4 can be further simplified as:

P(i)=F(I,i)=E(I)×γ×η×M(i→0) Equation 5

where F(I,i) is the function of current, I, and pixel number (or light extraction cell), i. Due to the linearity of the system, the required current, I, can also be determined by:

I=F⁻¹[P(i)] Equation 6

For a bi-directional LED input, the above discussion remains valid, except that the decay requirements are not necessary, since each pixel or light extraction cell is now the function of two light inputs, and Equation 5 becomes:

P(i)=F(I_{Left},I_{Right},i)=[E_{Left}(I_{Left})×γ_{Left}×M(i→0)+E_{Right}(I_{Right})×γ_{Right}×M(i→N)]×η Equation 7

In this case, for each P(i), there exist many combinations of (I_{Left}, I_{Right}), which can be adjusted based on performance requirements.

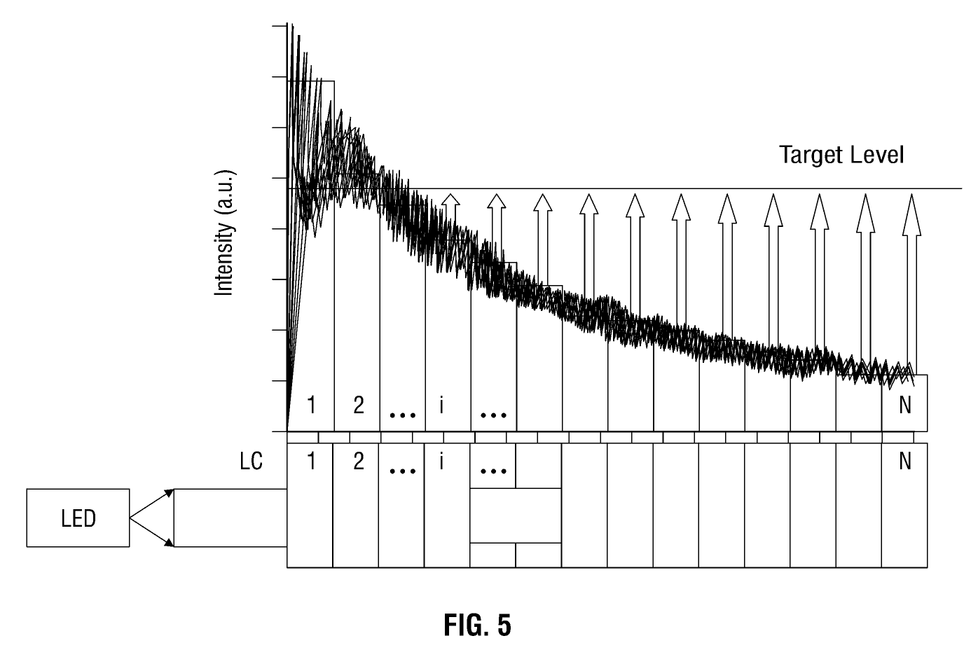

FIG. 5 is a schematic illustrating the light intensity increase (or decrease) for each light extraction cell (or pixel) required to achieve cross backlight panel uniformity of illuminations at desired intensity level when an LED is driven at current level I_{O}. The figure shows the light intensity increase (or decrease) required to compensate the losses in the waveguide. Based on Equation 6, the amount of light intensities can be transformed to a required amount of current.

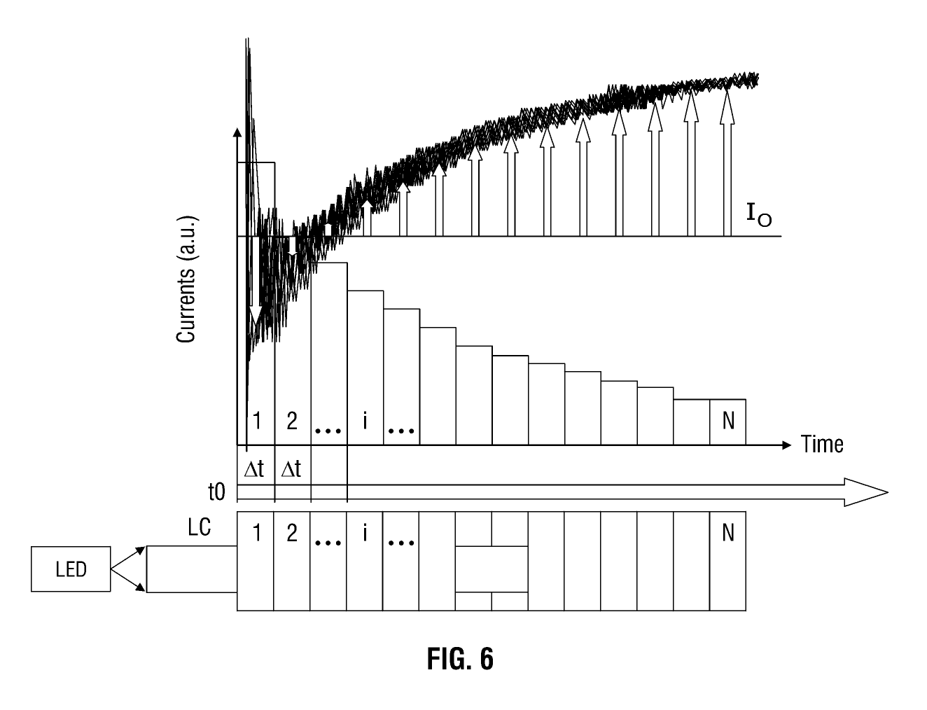

FIG. 6 is a schematic illustrating the compensation amounts for LED drive current at desired time slots required to achieve cross panel uniform illumination. At time slot tᵢ, front panel pixel (or light extraction cell) i is turned on to be synchronized to the LED, with currents I(tᵢ)=I_{O}+ΔI(tᵢ). Since only one pixel (or light extraction cell) is turned on for a desired period Δt, time domain synchronization can be to achieve uniform backlight illuminations, as shown. The current profile is proportional to inverted constant current light intensity profile.

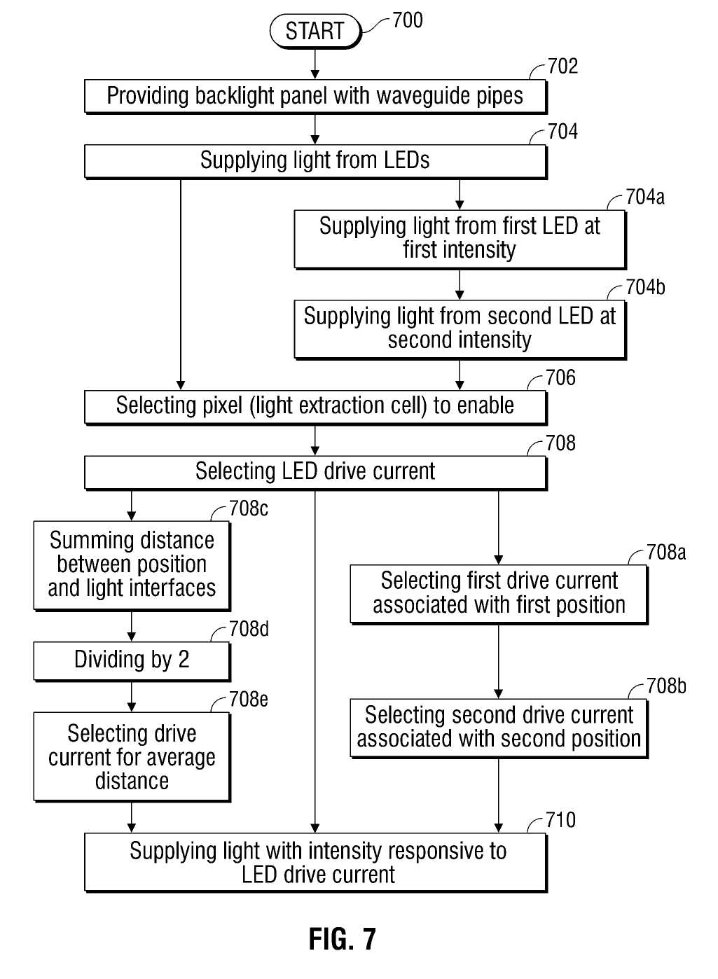

FIG. 7 is a flowchart illustrating a dynamic LED driving current compensation method for ensuring cross-panel backlight illumination uniformity in a display device. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. Generally however, the steps are performed in numerical order. The method starts at Step 700.

Step 702 provides a backlight panel with a plurality of waveguide pipes and a front panel with a plurality of rows, where each row overlies a corresponding waveguide pipe and includes a plurality of selectively enabled pixels formed in a sequence along the row. Step 704 supplies light from a plurality of LEDs, where each LED supplies light to a corresponding waveguide pipe. For each front panel row, Step 706 selects a pixel to enable. For each front panel row, Step 708 selects an LED drive current in response to the enabled pixel. As noted above in the discussion of FIGS. 2A and 2B, an array of light extraction cells may be interposed between the front panel and the waveguide pipe, and LED drive current may be selected in response to an enabled light extraction cell, underlying the enabled front panel pixel. Step 710 supplies light from each LED with an intensity responsive to the selected LED drive current. That is, each front panel row (or light extraction cell row) transmits uniform illumination, regardless of the selected pixel (light extraction cell).

In one aspect, Step 702 provides the backlight panel with waveguide pipes having a first light interface and a plurality of top surface positions. Each position is associated with a pixel in a corresponding front panel row, and each position is a predetermined distance from the first light interface. Then, selecting the LED drive current in Step 708 includes selecting the LED drive current in response to the distance between the waveguide pipe position underlying an enabled pixel in a corresponding front panel row and the first light interface. The waveguide pipes have an illumination loss between the first light interface and a top surface position responsive to the distance between the position and the first light interface.

For example, Step 708a may select a first LED drive current in response to enabling a first pixel in a corresponding first front panel row associated with a first position in a corresponding waveguide pipe, where the first position is a first distance from the first light interface. Then, Step 708b selects a second LED drive current, greater than the first LED drive current, in response to subsequently enabling a second pixel in the first panel row associated with a second position in the corresponding waveguide pipe that is a second distance from the first light interface, where the second distance is greater than the first distance.

In another aspect, Step 702 provides waveguide pipes, each having a bi-direction light interface with the first light interface proximate to a waveguide pipe first end and a second light interface proximate to a waveguide pipe second end. Supplying light to each LED in Step 704 includes a first and second LED respectively supplying light to first and second light interfaces of a corresponding waveguide pipe. Then, selecting the LED drive current in Step 708 includes selecting a first drive current for the first LED and second drive current for the second LED respectively responsive to the distances between the waveguide position underlying an enabled pixel in a corresponding front panel row, and the first and second light interfaces. That is, Step 704a supplies light from the first LED with a first intensity in response to the first drive current signal, and Step 704b supplies light from the second LED supplies light with a second intensity in response to the second drive current signal.

In one aspect, Step 702 provides waveguide pipes with an illumination loss between a light interface and a top surface position of an enabled pixel in a corresponding front panel row that linearly increases in response to the respective distances of the position from the first and second light interfaces. Then, selecting the first and second LED drive currents in Step 708 includes the following substeps. Step 708c sums the distance between the top surface position and the first light interface, with the distance between the position and the second light interface. Step 708d divides the summed distance by 2, creating an average distance. Step 708e selects an equal drive current for each of the first and second LEDs responsive to the average distance.

A display with illumination loss compensating LED drive currents has been provided. Examples of particular materials and dimensions have been given to illustrate the invention, but the invention is not limited to just these examples. Other variations and embodiments of the invention will occur to those skilled in the art.

We claim:

1. A dynamic light emitting diode (LED) driving current compensation method for ensuring cross-panel backlight illumination uniformity in a display device, the method comprising:
providing a backlight panel with a plurality of waveguide pipes and a front panel with a plurality of rows, where each row overlies a corresponding waveguide pipe and includes a plurality of selectively enabled pixels formed in a sequence along the row;
supplying light from a plurality of LEDs, where each LED supplies light to a corresponding waveguide pipe;
for each front panel row, selecting a pixel to enable; and,
for each front panel row, selecting an LED drive current in response to the enabled pixel.

2. The method of claim 1 wherein providing the backlight panel includes providing each waveguide pipe with a first light interface and a plurality of top surface positions, and where each position is associated with a pixel in a corresponding front panel row and each position is a predetermined distance from the first light interface; and,
wherein selecting the LED drive current includes selecting the LED drive current in response to the distance between the waveguide pipe position underlying an enabled pixel in a corresponding front panel row and the first light interface.

3. The method of claim 2 wherein providing the backlight panel includes providing each waveguide pipe with a first light interface;
wherein selecting the LED drive current includes:
selecting a first LED drive current in response to enabling a first pixel in a corresponding first front panel row associated with a first position in a corresponding waveguide pipe, where the first position is a first distance from the first light interface; and,
selecting a second LED drive current, greater than the first LED drive current, in response to subsequently enabling a second pixel in the first panel row associated with a second position in the corresponding waveguide pipe that is a second distance from the first light interface, where the second distance is greater than the first distance.

4. The method of claim 3 wherein providing the backlight panel includes providing waveguide pipes with an illumination loss between the first light interface and a top surface position responsive to the distance between the position and the first light interface.

5. The method of claim 1 further comprising:
supplying light from each LED with an intensity responsive to the selected LED drive current.

6. The method of claim 5 wherein supplying light from each LED includes each front panel row transmitting uniform illumination, regardless of the selected pixel.

7. The method of claim 2 wherein providing the backlight panel includes providing each waveguide pipe having a bi-direction light interface with the first light interface proximate to a waveguide pipe first end and a second light interface proximate to a waveguide pipe second end;
wherein each LED supplying light to the corresponding row includes a first and second LED respectively supplying light to first and second light interfaces of a corresponding waveguide pipe; and,
wherein selecting the LED drive current includes selecting a first drive current for the first LED and second drive current for the second LED respectively responsive to the distances between the waveguide position underlying an enabled pixel in a corresponding front panel row, and the first and second light interfaces.

8. The method of claim 7 wherein each LED supplying light to the corresponding row includes:
supplying light from the first LED with a first intensity in response to the first drive current signal; and,
supplying light from the second LED with a second intensity in response to the second drive current signal.

9. The method of claim 7 wherein providing the backlight panel includes providing each waveguide pipe with an illumination loss between a light interface and a top surface position of an enabled pixel in a corresponding front panel row that linearly increases in response to the respective distances of the position from the first and second light interfaces; and,
wherein selecting the first and second LED drive currents includes:
summing the distance between the top surface position and the first light interface, with the distance between the position and the second light interface;
dividing the summed distance by 2, creating an average distance;
selecting an equal drive current for each of the first and second LEDs responsive to the average distance.

10. A display device with dynamic light emitting diode (LED) driving current compensation for ensuring cross-panel backlight illumination uniformity, the device comprising:
a backlight panel with a plurality of waveguide pipes, each waveguide pipe having an optical interface and a top surface to supply-redirected light received via the optical interface;
a front panel including a plurality of rows, where each row overlies the top surface of a corresponding waveguide pipe, where each row includes a plurality of pixels formed in a sequence along the row, and where each pixel has an electrical input to accept a pixel selection signal for enabling a selected pixel to transmit redirected light received from a corresponding waveguide pipe;
a plurality of LEDs, each LED having an electrical input to accept a drive current signal and an optical interface to supply light to a corresponding waveguide pipe optical interface with an intensity responsive to the drive current signal; and,
an LED compensation module having an electrical input to accept the pixel selection signal for each row and an output to supply the drive current signal to each LED, where the drive current signal to each LED is responsive to the selected pixel in a corresponding front panel row.

11. The device of claim 10 wherein the top surface of each waveguide pipe includes a sequence of positions having a predetermined distance from the optical interface, where each position is associated with a pixel in a corresponding front panel row; and,
wherein the LED compensation module supplies the drive current signal to an LED in response to the distance between the optical interface and waveguide position in a corresponding waveguide pipe, where the waveguide position underlies a selected pixel in a corresponding front panel row.

12. The device of claim 11 wherein each waveguide pipe includes a first optical interface;
wherein the LED compensation module supplies a first drive current signal to a first LED in response to a first pixel being enabled in a corresponding front panel row, where a first position in a corresponding waveguide pipe underlying the first pixel is a first distance from the first optical interface;
wherein the LED compensation module supplies a second drive current signal to the first LED, in response to a second pixel being subsequently enabled in the corresponding front panel row, where a second position in the corresponding waveguide pipe underlying the second pixel is a second distance from the first light interface, and the second distance is greater than the first distance; and,
wherein the first LED supplies light with a first intensity via the first optical interface in response to the first drive current signal, and supplies light with a second intensity in response to the second drive current signal, where the second intensity is greater than the first intensity.

13. The device of claim 11 wherein each waveguide pipe has an illumination loss between the light interface and a position in the top surface, responsive to the distance of the position from the light interface.

14. The device of claim 10 wherein each front panel row transmits uniform backlight illumination, regardless of which pixel is enabled in the row.

15. The device of claim 11 wherein each waveguide pipe includes a bi-direction light interface, with the first light interface proximate to a first end of each waveguide pipe and a second light interface proximate to a second end of each waveguide pipe;
wherein a plurality of LEDs supply light to the second light interfaces of the waveguide pipes;
wherein a first LED supplies light to the first optical interface of a first waveguide pipe and a second LED supplies light to the second optical interface of the first waveguide pipe;
wherein the LED compensation module supplies a first drive current signal to the first LED in response to a first pixel in a corresponding front panel row being enabled, where a first position in a corresponding waveguide pipe underlying the first pixel is a first distance from the first optical interface, and supplies a second drive current signal to the second LED in response to the first position in the corresponding waveguide pipe being a second distance from the second optical interface.

16. The device of claim 15 wherein the first LED supplies light with a first intensity in response to the first drive current signal, and the second LED supplies light with a second intensity in response to the second drive current signal.

17. The device of claim 15 wherein each waveguide pipe has in illumination loss between a light interface and a position on the top surface that linearly increases in response to the distance between the position and a light interface; and,
wherein the LED compensation module sums the first distance with the second distance, divides the summed distance by 2, creating an average distance, and provides an equal drive current signals to the first and second LEDs responsive to the average distance.
